(19) United States
(12) Patent Application Publication
(10) Pub. No.: US 2024/0159547 A1
(43) Pub. Date: May 16, 2024

(54) INFORMATION PROCESSING APPARATUS

(71) Applicant: TOYOTA JIDOSHA KABUSHIKI KAISHA, Aichi-ken (JP)

(72) Inventors: Fumiyuki KAGARA, Sagamihara-shi (JP); Hiroyuki NISHIZAWA, Nagakute-shi (JP); Hirofumi AINO, Kawaguchi-shi (JP)

(21) Appl. No.: 18/502,081

(22) Filed: Nov. 6, 2023

(30) Foreign Application Priority Data
Nov. 16, 2022 (JP) 2022-183632

(51) Int. Cl. G01C 21/34

(52) U.S. Cl. CPC G01C 21/3453

(57) ABSTRACT

A driving assistance apparatus is an information processing apparatus. The driving assistance apparatus includes a memory and a controller. The memory is configured to store information on a plurality of rectangular sections partitioning a map and location information on a plurality of spots on the map. The controller is configured to extract a pair of adjacent points from among a departure point, a destination point, and at least one transit point on a route from the departure point to the destination point, and identify a smallest rectangular area including the pair of adjacent points, among rectangular areas configured to include at least one of the sections. The controller is configured to determine to provide a user with information on, out of the plurality of spots, a spot included in a search area based on the smallest rectangular area.

### CROSS-REFERENCE TO RELATED APPLICATION

This application claims priority to Japanese Patent Application No. 2022-183632 filed on Nov. 16, 2022, the entire contents of which are incorporated herein by reference.

### TECHNICAL FIELD

The present disclosure relates to an information processing apparatus.

### BACKGROUND

Technology for providing users with information on spots, such as facilities or sightseeing spots, is known. For example, Patent Literature (PTL) 1 describes a route search apparatus that presents a user with a list of stopover spots around the current location of a vehicle.

### CITATION LIST

### Patent Literature

PTL 1: JP 2020-101424 A

### SUMMARY

There is room for improvement with respect to technology for providing users with information on spots. For example, the technology presents the users with stopover spots in a range within a certain distance from the current position of a vehicle. Therefore, the technology cannot present the users with stopover spots within a wide range from a departure point to a destination point.

It would be helpful to improve technology for providing users with information on spots.

An information processing apparatus according to an embodiment of the present disclosure includes a memory and a controller. The memory is configured to store information on a plurality of rectangular sections partitioning a map and location information on a plurality of spots on the map. The controller is configured to extract a pair of adjacent points from among a departure point, a destination point, and at least one transit point on a route from the departure point to the destination point, and identify a smallest rectangular area including the pair of adjacent points, among rectangular areas configured to include at least one of the sections. The controller is configured to determine to provide a user with information on, out of the plurality of spots, a spot included in a search area based on the smallest rectangular area.

According to an embodiment of the present disclosure, technology for providing users with information on spots can be improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a sequence diagram illustrating an example of an operation procedure of the system illustrated in FIG. 1;

FIG. 3 is a sequence diagram illustrating the example of the operation procedure of the system illustrated in FIG. 1; and

FIG. 4 is a diagram for explaining a search area.

### DETAILED DESCRIPTION

An embodiment of the present disclosure will be described below, with reference to the drawings.

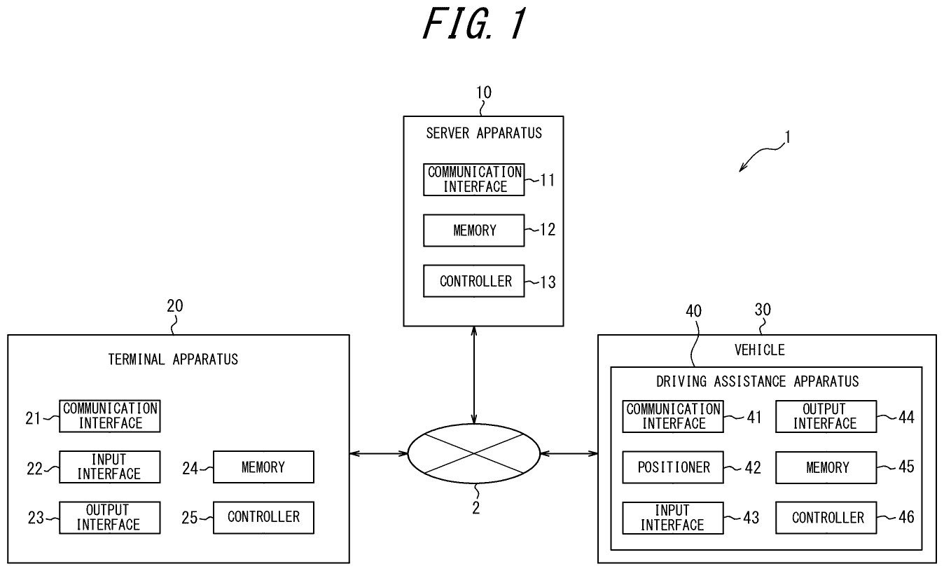

As illustrated in FIG. 1, a system 1 includes a server apparatus 10, a terminal apparatus 20, and a vehicle 30. For the sake of simplicity, FIG. 1 illustrates the system 1 with one server apparatus 10, one terminal apparatus 20, and one vehicle 30. However, the system 1 may include any number of server apparatuses 10, any number of terminal apparatuses 20, and any number of vehicles 30.

The server apparatus 10, the terminal apparatus 20, and the vehicle 30 can communicate via a network 2. The network 2 may be any network including a mobile communication network, the Internet, or the like.

The system 1 can provide a user who plans to travel with information on spots that the user has pre-registered. The user may travel by any transportation means, such as a vehicle, bicycle, or on foot. In the present embodiment, the user is transported by the vehicle 30.

The server apparatus 10 is an information processing apparatus. The server apparatus 10 is configured to include one computer or a plurality of computers that can communicate with each other, for example.

The terminal apparatus 20 is an information processing apparatus. The terminal apparatuses 20 is, for example, a smartphone, a tablet, a personal computer (PC), or the like. The terminal apparatus 20 is used by a user. The user of the terminal apparatus 20 is also the user of the vehicle 30. The user of the terminal apparatus 20 operates the terminal apparatus 20 to register in advance the spots he/she wishes to stop at when traveling by vehicle 30. The spots are, for example, facilities, sightseeing spots, or the like.

The vehicle 30 may be any appropriate type of automobile. The vehicle 30 is equipped with a driving assistance apparatus 40. The driving assistance apparatus 40 is an information processing apparatus. The driving assistance apparatus 40 may, for example, be a car navigation device.

(Configuration of Server Apparatus)

The server apparatus 10 includes a communication interface 11, a memory 12, and a controller 13.

The communication interface 11 is configured to include at least one communication module for connection to the network 2. For example, the communication module is a communication module compliant with a standard such as a wired Local Area Network (LAN) or a wireless LAN. The communication interface 11 is connectable to the network 2 via a wired LAN or a wireless LAN using the communication module.

The memory 12 is configured to include at least one semiconductor memory, at least one magnetic memory, at least one optical memory, or a combination of at least two of these. The memory 12 may function as a main memory, an auxiliary memory, or a cache memory. The memory 12 stores data to be used for operations of the server apparatus 10 and data obtained by the operations of the server apparatus 10. For example, the memory 12 stores map information.

The map information stored in the memory 12 includes information on a plurality of nodes and a plurality of links. The nodes indicate, for example, points at which a road type changes at an intersection or road. The links indicate roads that connect two nodes.

The map information stored in the memory 12 includes information on a plurality of rectangular sections that partition a map. The sections are, for example, square, rectangular, or the like. For example, the map can be partitioned by multiple sections by dividing the map along each of latitude and longitude. The information on the sections includes, for example, the size of the sections, information on corresponding latitude and longitude, and the like. The information on the sections of different sizes for the single map may be stored in the memory 12. The sections are also referred to as meshes. As the sections, meshes provided by a public agency such as the Ministry of Land, Infrastructure, Transport and Tourism may be used, or meshes set independently by the system 1 may be used. When the meshes provided by the MLIT is used as the sections, the sections are referred to as primary, secondary, 2.5, or tertiary meshes, depending on its size. The sizes of the primary, secondary, 2.5, and tertiary meshes are 80 [km]×80 [km], 10 [km]×10 [km], 5 [km]×5 [km], and 1 [km]×1 [km], respectively.

The controller 13 is configured to include at least one processor, at least one dedicated circuit, or a combination thereof. The processor is, for example, a general purpose processor such as a Central Processing Unit (CPU) or a Graphics Processing Unit (GPU), or a dedicated processor that is dedicated to a specific process. The controller 13 executes processes related to operations of the server apparatus 10 while controlling components of the server apparatus 10.

(Configuration of Terminal Apparatus)

The terminal apparatus 20 includes a communication interface 21, an input interface 22, an output interface 23, a memory 24, and a controller 25.

The communication interface 21 is configured to include at least one communication module for connection to the network 2. The communication module is a communication module compliant with a mobile communication standard such as Long Term Evolution (LTE), 4th Generation (4G), or 5th Generation (5G).

The input interface 22 is capable of accepting an input from a user. The input interface 22 is configured to include at least one interface for input that is capable of accepting the input from the user. The interface for input is, for example, a physical key, a capacitive key, a pointing device, a touch screen integrally provided with a display, a microphone, or the like.

The output interface 23 can output data. The output interface 23 is configured to include at least one interface for output that is capable of outputting the data. The interface for output is, for example, a display, a speaker, or the like. The display is, for example, a liquid crystal display (LCD), an organic electro-luminescent (EL) display, or the like.

The hardware configuration of the memory 24 may be the same or similar to that of the memory 12. The memory 24 stores data to be used for operations of the terminal apparatus 20 and data obtained by the operations of the terminal apparatus 20.

The hardware configuration of the controller 25 may be the same or similar to that of the controller 13. The controller 25 executes processes related to operations of the terminal apparatus 20 while controlling components of the terminal apparatus 20.

(Configuration of Driving Assistance Apparatus)

The driving assistance apparatus 40 includes a communication interface 41, a positioner 42, an input interface 43, an output interface 44, a memory 45, and a controller 46.

The communication interface 41 is configured to include at least one communication module for connection to the network 2. The hardware configuration of the communication interface 41 may be the same or similar to that of the communication interface 21.

The positioner 42 is capable of acquiring location information on the vehicle 30 with the driving assistance apparatus 40. The positioner 42 is configured to include at least one receiving module compliant with a satellite positioning system. The receiving module is, for example, a receiving module corresponding to the Global Positioning System (GPS).

The input interface 43 is capable of accepting an input from a user. The hardware configuration of the input interface 43 may be the same or similar to that of the input interface 22.

The output interface 44 is capable of outputting data. The hardware configuration of output interface 44 may be the same or similar to that of the output interface 23.

The hardware configuration of the memory 45 may be the same or similar to that of the memory 12. The memory 45 stores data to be used for operations of the driving assistance apparatus 40 and data obtained by the operations of the driving assistance apparatus 40.

The hardware configuration of the controller 46 may be the same or similar to that of the controller 13. The controller 46 executes processes related to the operations of the driving assistance apparatus 40 while controlling components of the driving assistance apparatus 40.

(Operations of System)

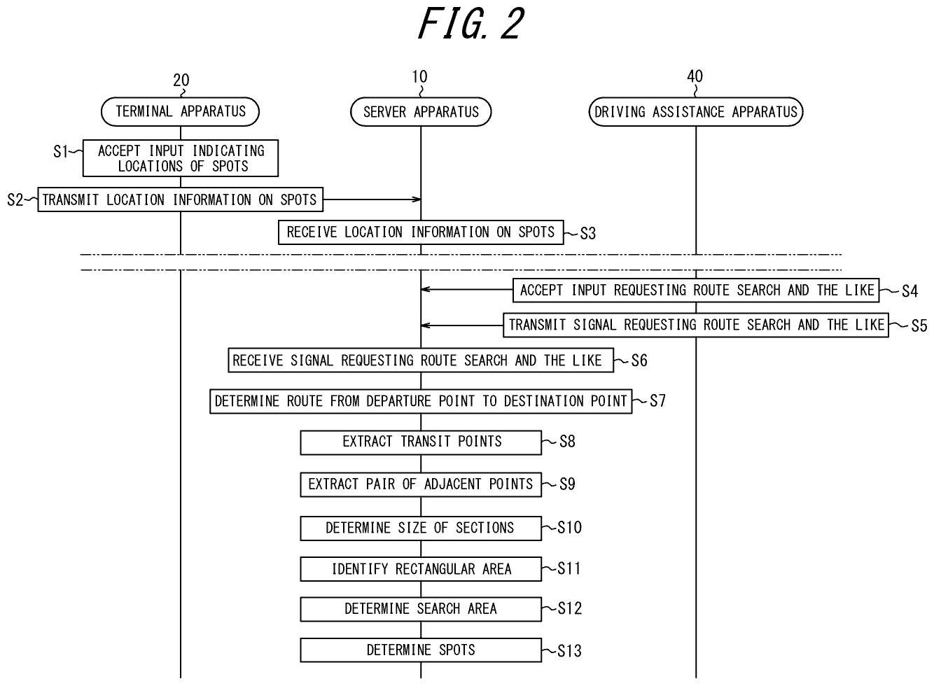

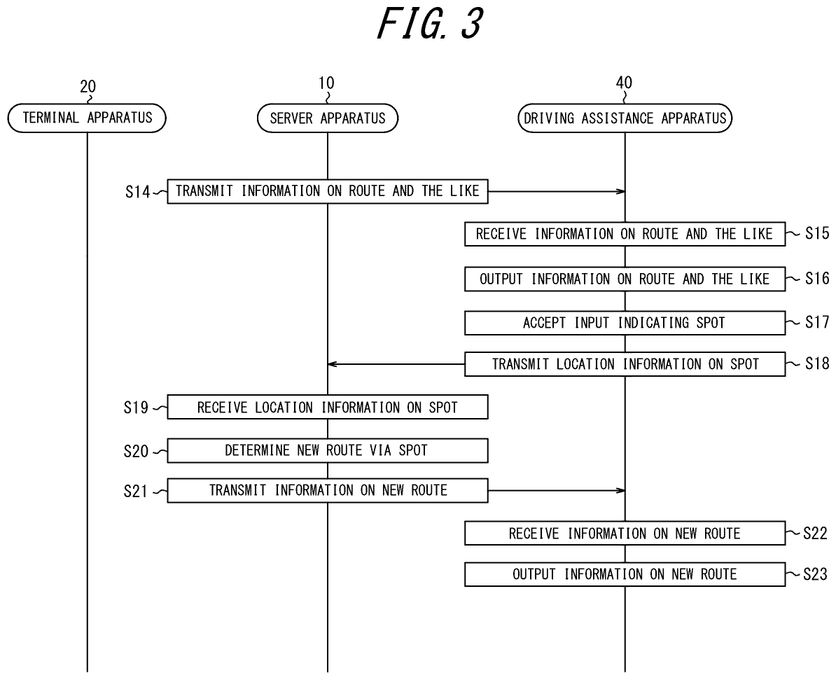

FIGS. 2 and 3 are sequence diagrams illustrating an example of an operation procedure of the system 1 illustrated in FIG. 1.

In the process of step S1, in the terminal apparatus 20, the controller accepts, by the input interface 22, an input indicating locations of spots. The user enters an input on the input interface 22 indicating the locations of the spots he/she wishes to stop at when traveling by vehicle 30.

In the process of step S2, in the terminal apparatus 20, the controller transmits, by the communication interface 21, location information on the spots accepted in the process of step S1, to the server apparatus 10 via the network 2 (step S2).

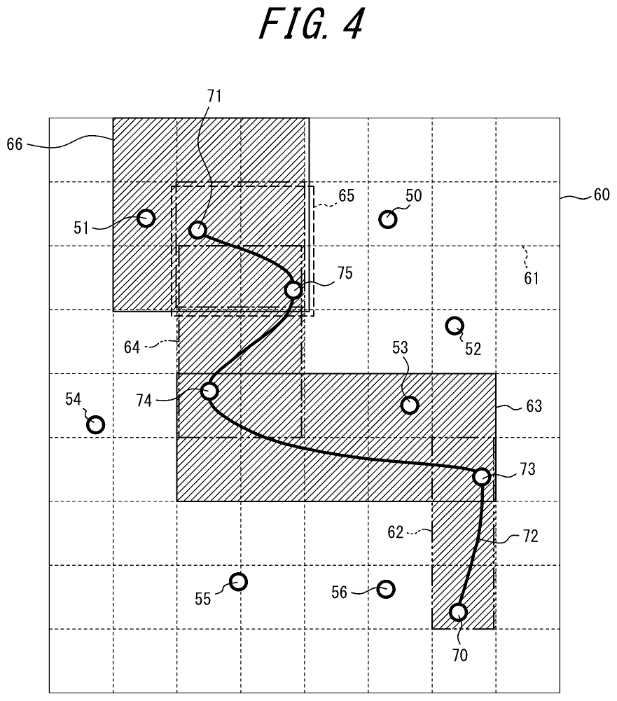

In the process of step S3, in the server apparatus 10, the controller 13 receives, by the communication interface 11, the location information on the spots from the terminal apparatus 20 via the network 2. The controller 13 stores, in the memory 12, the received location information on the spots. For example, the controller 13 stores location information on spots 50, 51, 52, 53, 54, 55, 56, 57 in the memory 12 as illustrated in FIG. 4.

The process of steps S1 to S3 may be performed at any time, for example, before the user travels by the vehicle 30. By executing steps S1 to S3, the spots that the user wants to stop by are pre-registered in the server apparatus 10 before the user travels by the vehicle 30.

In the process of step S4, in the driving assistance apparatus 40, the controller 46 accepts an input requesting route search, an input indicating a departure point, and an input indicating a destination point by the input interface 43. These inputs are entered into the input interface 43 by the user, for example, when the user is traveling by vehicle 30 to the destination point or when planning a trip to the destination point by vehicle 30. Instead of accepting the input indicating the departure point, the controller 46 may use the positioner 42 to obtain the current position of the vehicle 30. In this case, the controller 46 uses the obtained current position of the vehicle 30 as the departure point.

In the process of step S5, in the driving assistance apparatus 40, the controller 46 transmits, by the communication interface 41, a signal requesting route search, location information on the departure point, location information on the destination point, and a signal indicating a transportation means of the user to the server apparatus 10 via the network 2. The signal indicating the transportation means of the user is, for example, a signal indicating a vehicle, bicycle, or walking as the transportation means of the user. In the present embodiment, the controller 46 transmits a signal indicating a vehicle as a signal indicating the transportation means of the user.

In the process of step S6, in the server apparatus 10, the controller 13 receives, by the communication interface 11, the signal requesting route search, the location information on the departure point, the location information on the destination point, and the signal indicating the transportation means of the user from the driving assistance apparatus 40 via the network 2.

In the process of step S7, in the server apparatus 10, the controller 13 executes a route search from the departure point to the destination point using the information on the plurality of nodes and links stored in the memory 12. The controller 13 may execute the route search from the departure point to the destination point by any route search algorithm. The controller 13 executes the route search from the departure point to the destination point and determines a route from the departure point to the destination point on the map. The route from the departure point to the destination point is configured to include at least one or more of the nodes and links.

For example, the controller 13 executes a route search from a departure point 70 to a destination point 71 in a map 60 illustrated in FIG. 4. The controller 13 executes the route search and determines a route 72 from the departure point 70 to the destination point 71.

In the process of step S8, in the server apparatus 10, the controller 13 extracts at least one transit point from the determined route. The controller 13 may extract multiple transit points or a single transit point. If the determined route is configured to include nodes, the controller 13 may extract the nodes constituting the route as the transit points. The controller 13 may extract intersections on the determined route as the transit points. The controller 13 may extract points that divide the route into equal intervals as the transit points. For example, in FIG. 4, the controller 13 extracts transit points 73, 74, and 75 from the route 72.

In the process of step S9, in the server apparatus 10, the controller 13 extracts a pair of adjacent points on the route from among the departure point, the destination point, and the transit points. For example, in FIG. 4, the controller 13 extracts pairs of the departure point 70 and the transit point 73, the transit point 73 and the transit point 74, the transit point 74 and the transit point 75, and the transit point 75 and the destination point 71, which are adjacent to each other on the route 72.

In step S10, in the server apparatus 10, the controller 13 determines the size of the sections that partition the map. The controller 13 determines the size of the sections that partition the map so that the size of the sections is according to the user's transportation means received in the process of step S6. As an example, the controller 13 may determine the size of the sections so that the faster the user travels by the transportation means, the more the map is partitioned by the larger-sized sections. For example, users travels faster on foot, bicycle, and vehicle, in that order. Therefore, when the primary to tertiary meshes described above are employed for the sections, the controller 13 may determine the size of the sections that partition the map to be 1 [km]×1 [km] when the user's transportation means is on foot. When the user's transportation means is a bicycle, the controller 13 may determine the size of the sections that partition the map to be 2.5 [km]×2.5 [km]. When the user's transportation means is a vehicle, the controller 13 may determine the size of the sections that partition the map to be 10 [km]×10 [km]. When the controller 13 determines the size of the sections, it acquires information on the sections of the determined size from the memory 12 and partitions the map. For example, in FIG. 4, the controller 13 partitions map 60 by sections 61. The size of the sections 61 is 10 [km]×10 [km].

In the process of step S11, the controller 13 identifies a smallest rectangular area that includes the pair of adjacent points extracted in the process of step S9, among rectangular areas configured to include at least one of the sections. The smallest rectangular area may include one or more sections. The smallest rectangular area may be constituted of one or more sections. The rectangular areas are, for example, square or rectangular. For example, in FIG. 4, the controller 13 identifies a smallest rectangular area 62 that includes the pair of the departure point 70 and the transit point 73, among rectangular areas configured to include at least one of the sections 61. The controller 13 identifies a smallest rectangular area 63 that includes the pair of the transit points 73 and 74, among the rectangular areas configured to include at least one of the sections 61. The controller 13 identifies a smallest rectangular area 64 that includes the pair of the transit points 74 and 75, among the rectangular areas configured to include at least one of the sections 61. The controller 13 identifies a smallest rectangular area 65 that includes the pair of the transit point 75 and the destination point 71, among the rectangular areas configured to include at least one of the sections 61.

In the process of step S11, the controller 13 may identify the smallest rectangular areas that include the pairs of adjacent points for all of the pairs of adjacent points extracted in the process of step S9, or it may identify the smallest rectangular areas that includes the pairs of adjacent points for some of the pairs of adjacent points extracted in the process of step S9.

In the process of step S11, for the destination point, the controller 13 may identify, as the rectangular area, an area configured to include the section enclosing the destination point. As an example, the controller 13 may identify, as the rectangular area, an area constituted of N×N (N is an odd number greater than or equal to 3) sections centered on the section including the destination point. For example, in FIG. 4, the controller 13 identifies, as a rectangular area 66, an area constituted of 3×3 sections centered on the section 61 enclosing the destination point 71.

In the process of step S12, in the server apparatus 10, the controller 13 determines a search area based on the rectangular area identified in the process of step S11. The search area is an area in which spots to be provided to the user are searched. As an example, the controller 13 may determine, as the search area, the combined rectangular areas identified. In combining the identified rectangular areas, the controller 13 may set overlapping portions of the multiple rectangular areas as a single portion. For example, in FIG. 4, the search area is hatched. In FIG. 4, the controller 13 determines the combined rectangular areas 62, 63, 64, 65, and 66 as the search area. The controller 13 sets each of an overlapping portion of the rectangular areas 62 and 63, an overlapping portion of the rectangular areas 63 and 64, and an overlapping portion of the rectangular areas 64 to 66 as a single portion. As another example, the controller 13 may determine the search area to be the combined area of the identified rectangular areas and the sections surrounding the perimeter of the combined area. For example, the controller 13 may determine the area hatched in FIG. 4 and the sections 61 surrounding the hatched area to be the search area. As yet another example, the controller 13 may determine the search area to be the combined area of the identified rectangular areas and the area where the sections are arranged so that the thickness of the sections is a predetermined number of sections around the perimeter of the combined area. The predetermined number may be set according to the transportation means.

In the process of step S13, in the server apparatus 10, the controller 13 extracts spots included in the search area determined in the process of step S11, from among the plurality of spots stored in the memory 12. The controller 13 determines to provide the user with information on the extracted spots. For example, in FIG. 4, the controller 13 extracts spots 51 and 53 included in the hatched search area from the spots 50 to 56. The controller 13 determines to provide the user with information on the spots 51 and 53. In the present embodiment, the controller 13 provides location information on the spots, as the information on the spots.

After executing the process of step S13, the system 1 proceeds to the process of step S14 illustrated in FIG. 3.

In the process of step S14, in the server apparatus 10, the controller 13 transmits the information on the route determined in the process of step S7 and the location information on the spots determined in the process of step S13 to the driving assistance apparatus 40 via the network 2 by the communication interface 11.

In the process of step S15, in the driving assistance apparatus 40, the controller 46 receives, by the communication interface 41, the information on the route and the location information on the spots from the server apparatus via the network 2.

In the process of step S16, in the driving assistance apparatus 40, the controller 46 controls the output interface 44 to output the information on the route and the location information on the spots received in the process of step S15. For example, the controller 46 displays the information on the route and the location information on the spots on a display of the output interface 44. By executing the process in step S16, the user can grasp the route from the departure point to the destination point and the locations of the spots around the route. The user can select a spot to stop by the vehicle 30 from among the spots output from the output interface 44. The user enters an input indicating the selected spot into the input interface 43 of the driving assistance apparatus 40.

In the process of step S17, in the driving assistance apparatus 40, the controller 46 accepts an input indicating the spot selected from among the spots output to the output interface 44 by the input interface 43. The controller 46 transmits, by the communication interface 41, the location information on the spot accepted by the input interface 43 to the server apparatus 10 via the network 2 (step S18).

In the process of step S19, in the server apparatus 10, the controller 13 receives, by the communication interface 11, the location information on the spot via the network 2. In other words, in the process of step S19, the controller 13 receives the location information on at least any of the plurality of spots that is determined to be provided to the user in the process of step S13. When the controller 13 receives the location information on the spot, it determines a new route from the departure point to the destination point, which is via the received spot (step S20). For example, assume that the controller 13 receives the location information on the spot 53 as illustrate in FIG. 4. In this case, the controller 13 determines a new route from the departure point 70 to the destination point 71, which is via the spot 53. The controller 13 transmits, by the communication interface 11, information on the new route to the driving assistance apparatus 40 via the network 2 (step S21).

In the process of step S22, in the driving assistance apparatus 40, the controller 46 receives, by the communication interface 41, the information on the new route from the server apparatus 10 via the network 2. The controller 46 controls the output interface 44 to output the information on the new route (step S23). For example, the controller 46 displays the information on the new route on the display of the output interface 44. By executing the process of step S23, the user can drive the vehicle 30 along the new route and stop at the selected spot.

Thus, in the server apparatus 10 of the present embodiment, the controller 13 determines to provide the user with the information on the spots included in the search area, among the plurality of spots stored in the memory 12.

Here, as a comparative example, consider providing the user with information on spots in a range within a certain distance from the current position of the vehicle 30. In this comparison, it is not possible to provide users with information on spots within a wide range from the departure point to the destination point. The server apparatus 10 will also search for spots within a certain distance at each location on the route from the departure point to the destination point. This configuration complicates the calculation process performed by the server apparatus 10 in the comparative example. Therefore, in the comparative example, the server apparatus 10 is required to have high computing power.

In contrast to this comparative example, in the server apparatus 10 of the present embodiment, the controller 13 extracts the pair of adjacent points from among the departure point, the destination point, and the at least one transit point on the route. The controller 13 identifies the smallest rectangular area that includes the pair of adjacent points among the rectangular areas configured to include at least one of the sections. With this configuration, the search area based on the smallest rectangular area identified can be a large area from the departure point to the destination point. Furthermore, in the present embodiment, the controller 13 provides the user with the information on the spots included in the search area, which is such a wide range from the departure point to the destination point. As a result, unlike the comparative example, the present embodiment can provide the user with the information on the spots within the wide range from the departure point to the destination point. Furthermore, unlike the comparative example, the present embodiment does not need to search for spots in a region within a certain di stance at each location on the route from the departure point to the destination point. With this configuration, the calculation process performed by the server apparatus can be easier than in the comparative example. As a result, the server apparatus 10 is not required to have high computing power in the present embodiment. In addition, the present embodiment can reduce the load on the server apparatus 10, such as the computation process. By reducing the load on the server apparatus 10 in terms of calculation processing, etc., the server apparatus 10 can simultaneously respond to requests for route searches, etc., from a greater number of devices.

Therefore, according to the present embodiment, technology for providing users with information on spots can be improved.

Furthermore, the size of the sections that partition the map in the present embodiment may be sized according to the user's transportation means. By partitioning the map by the sections sized according to the user's transportation means, the search area for searching for spots can be sized according to the user's range of activity. The search area is sized according to the user's range of activity, thereby providing the user with information on appropriate spots.

In the server apparatus 10 of the present embodiment, the controller 13 may extract the nodes that constitute the route from the departure point to the destination point as transit points. By extracting nodes that constitute the route as the transit points, for example, the load on the calculation process of the server apparatus 10 can be reduced compared to the case where transit points are extracted by a dedicated calculation process.

In the server apparatus 10 of the present embodiment, for the destination point, the controller 13 may identify, as the rectangular area, the area configured to include the section enclosing the destination point. For example, as illustrated in FIG. 4, the controller 13 may identify the area configured to include the section 61 that includes the destination point 71 as the rectangular area 66. After reaching the destination point, the user can freely move around the area around the destination point. In other words, the user's range of action after reaching the destination point can be wider than the user's range of action while traveling along the route. By identifying, as the rectangular area, the area configured to include the section enclosing the destination point in this way, more information on spots can be provided to the user at the destination point. This configuration improves convenience of the user.

In the server apparatus 10 of the present embodiment, the controller 13 may receive the location information on at least any of the plurality of spots that is determined to be provided to the user by the communication interface 11. In this case, the controller 13 may determine the new route from the departure point to the destination point, which is via the received spot. This configuration allows the user to drive the vehicle 30 along the new route and stop at the selected spot. As a result, convenience of the user can be improved.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, the process executed by the server apparatus 10 may be executed by any information processing apparatus. As another example, the terminal apparatus 20 as the information processing apparatus may execute the process performed by the server apparatus 10. In this case, in the terminal apparatus 20, the controller 25 may accept an input indicating the user's transportation means by the input interface 22 before executing step S10. As mentioned above, the present embodiment facilitates the calculation process performed by the server apparatus 10. Therefore, even the terminal apparatus 20, which has less computing power than the server apparatus 10, can perform the same processing as the server apparatus 10 at relatively high speed. Identical or similarly, as yet another example, the driving assistance apparatus as the information processing apparatus may execute the process performed by the server apparatus 10.

1. An information processing apparatus comprising:
a memory configured to store information on a plurality of rectangular sections partitioning a map and location information on a plurality of spots on the map; and
a controller,
wherein the controller is configured to:
extract a pair of adjacent points from among a departure point, a destination point, and at least one transit point on a route from the departure point to the destination point;
identify a smallest rectangular area including the pair of adjacent points, among rectangular areas configured to include at least one of the sections; and
determine to provide a user with information on, out of the plurality of spots, a spot included in a search area based on the smallest rectangular area.

2. The information processing apparatus according to claim 1, wherein the sections are sized according to a transportation means of the user.

3. The information processing apparatus according to claim 1, wherein the controller is configured to extract, as the transit point, a node constituting the route.

4. The information processing apparatus according to claim 1, wherein the controller is configured to identify, as a rectangular area, an area configured to include a section enclosing the destination point.

5. The information processing apparatus according to claim 1, further comprising a communication interface,
wherein upon receiving, by the communication interface, location information on at least any of a plurality of spots that is determined to be provided to the user, the controller is configured to determine a new route from the departure point to the destination point via the spot on which the location information has been received.
